(19) United States
(12) Patent Application Publication
(10) Pub. No.: US 2011/0206870 A1
(43) Pub. Date: Aug. 25, 2011

(54) Body Structure For Furniture And Building Structures

(76) Inventor: Gosakan Aravamudan, Karnataka (IN)

(21) Appl. No.: 13/122,559

(22) PCT Filed: Sep. 29, 2009
(86) PCT No.: PCT/IN2009/000534

§ 371 Date: Apr. 5, 2011

(30) Foreign Application Priority Data
Oct. 6, 2008 (IN) 2454/CHE/2008

(51) Int. Cl. E06B 3/70; B32B 18/00; A47B 96/20; B29C 44/38

(52) U.S. Cl. 428/15; 264/45.1

(57) ABSTRACT

A body structure for a door and/or furniture is provided. The body structure comprises a first artificial stone skin backed with a first fiber layer, a second artificial stone skin backed with a second fiber layer, and a central composite core comprising porous ceramic blocks and porous ceramic pieces and structural foam or an artificial stone mix. A reinforcing grid is placed between the first artificial stone skin and the second artificial stone skin. The body structure for a door and/or furniture is manufactured by manufacturing artificial stone skins, manufacturing a central composite core comprising porous ceramic blocks and porous ceramic pieces between two of the artificial stone skins, and introducing a liquid mix of structural foam or an artificial stone mix between the artificial stone skins, whereby the structural foam or the artificial stone mix fills gaps between the porous ceramic blocks, sets to create the central composite core.

### CROSS REFERENCE TO RELATED APPLICATIONS

This application claims the benefit of the following patent applications:
1. Provisional patent application number 2454/CHE/2008 titled “Body Structure For Furniture And Building Structures”, filed on 6 Oct. 2008 in the Indian Patent Office.
2. PCT application number PCT/1N2009/000534 titled “Body Structure For Furniture And Building Structures”, filed on 29 Sep. 2009 in the Indian Patent Office.

The specifications of the above referenced patent applications are incorporated herein by reference in their entirety.

### BACKGROUND

This invention, in general, relates to building structures. More particularly, this invention relates to a body structure for furniture and building structures, for example, doors, tables, and windows.

Wood and its derivatives are currently the preferred choice of material for the fabrication of doors and windows in most parts of the world. Wood derivatives include medium density fiber board, etc. Fixtures, for example, doors and windows consume a large quantity of wood and place a large burden on our already shrinking environmental resources. There is an urgent need for a substitute for wood in such building structures that will reduce the environmental impact and also address the following disadvantages of utilizing wood.

If not properly taken care of, wood has a limited life. Wood may decay when exposed to moisture for long periods, and wood is prone to termite attack.

In tropical countries with excess rainfall, wood expands seasonally due to excess moisture content, as a result doors and windows get jammed and unworkable.

Wood and its derivatives, for example, plywood, medium density fiberboard, etc. create bulky constructions. For example, most doors and window products made of wood are an inch thick.

If colored images are to be applied on wood, it has to be in the form of coatings. However, coatings on wood or its derivatives have a limited life. These coatings may discolor or peel off. Wood is not amenable to be worked into a variety of surface textures.

Another limitation of wooden doors and windows is the higher cost of material, and accruing cost of fabrication. Furthermore, the construction of wooden doors and windows may require skilled labor.

There is an unmet need for overcoming the above mentioned drawbacks associated with the existing materials used for fabricating doors and windows. Moreover, there is a need for a long-standing structure as frequent replacements for doors and windows may be cumbersome and expensive.

Furthermore, there is a need for materials that possess properties, for example, abrasion resistance, dirt resistance, moisture resistance, impact resistance, fire resistance, frost resistance, thermal shock resistance, stain resistance, chemical resistance, and color permanence in order to achieve long durability.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The body structure disclosed herein for furniture and building structures addresses the above stated unmet needs. The body structure disclosed herein is a durable, fire resistant, moisture resistant, stain resistant, chemical resistant, and is an abrasion resistant body. Disclosed herein is a body structure for a door and/or other furniture, comprising a central composite core, a first artificial stone skin backed with a first fiber layer and a second artificial stone skin backed with a second fiber layer.

The body structure for the door and/or furniture comprises a first artificial stone skin backed with a first fiber layer, a second artificial stone skin backed with a second fiber layer, a central composite core positioned between the first artificial stone skin and the second artificial stone skin. The first artificial stone skin backed with the first fiber layer comprises an artificial stone mix and the first fiber layer. The first fiber layer is, for example, a glass fiber mat. The artificial stone mix comprises a polyester resin solution, an accelerator, a catalyst, quartz particles and additives. The additives are, for example, coupling agent, dispersing agent, pigments, etc. The polyester resin solution is, for example, a mixture of unsaturated polyester resin, styrene monomer, and methyl methacrylate. The central composite core comprises multiple porous ceramic blocks or porous ceramic pieces and a structural foam. The porous ceramic blocks or porous ceramic pieces comprise, for example, ball clay, china clay, feldspar, quartz, talc, wollastonite, calcium sulphate hemihydrate and hydrogen peroxide solution. The central composite core further comprises a reinforcing grid between the first artificial stone skin and the second artificial stone skin to provide greater rigidity to the body structure.

Ceramic is highly rigid and flame retardant. The structural foam is tough and flexible. The porous ceramic-structural foam composite provides a body structure that is highly rigid and yet flexible enough to withstand sudden impacts. The central composite core comprising porous ceramic and structural foam, flexes along with the artificial stone skin.

In another embodiment, the central composite core comprises a honeycomb structure placed between the first artificial stone skin and the second artificial stone skin. The honeycomb structure provides for a lightweight reinforcement to the body structure. The honeycomb structure is, for example, made of paper, plastic, metal or a composite.

A method of manufacturing the body structure for the door and/or furniture comprises manufacturing and placing one of the artificial stone skins on a planar surface, manufacturing and placing a central composite core on one of the artificial stone skins, and manufacturing and placing another of the artificial stone skins on the central composite core.

The first artificial stone skin backed with the first fiber layer is manufactured by dispersing a layer of an artificial stone mix uniformly over a planar work surface, compacting the dispersed artificial stone mix by applying pressure, placing the first fiber layer, and coating the first fiber layer with a thin coating of resin mix. The first fiber layer is, for example, a glass fiber mat. The artificial stone mix is, for example, compacted by vibrocompaction.

The central composite core comprises one or more of multiple porous ceramic blocks and porous ceramic pieces, and structural foam. Manufacturing the central composite core comprises: placing a reinforcing grid on the first artificial stone skin, placing one or more of the porous ceramic blocks and the porous ceramic pieces on the first artificial stone skin and inside the reinforcing grid, pouring liquid structural foam on the porous ceramic blocks or pieces whereby the structural foam fills gaps between the porous ceramic blocks and the porous ceramic pieces to create a solid central composite core, and placing the second artificial stone skin backed with the second fiber layer on the central composite core. The structural foam liquid is, for example, a polyurethane foam liquid comprising a polyol and a polyisocyanate. The polyol and the polyisocyanate is mixed in a predetermined ratio and poured whereby the liquid foams and sets into a solid structural foam. The second artificial stone skin backed with the second fiber layer is manufactured similar to the first artificial stone skin backed with the first fiber layer.

A method of manufacturing the body structure for the door and/or furniture, comprises manufacturing and placing one of the artificial stone skins on a planar surface, manufacturing and placing a central composite core on one of the artificial stone skins, and manufacturing and placing another of the artificial stone skins on the central composite core. The first artificial stone skin backed with the first fiber layer is manufactured by dispersing a layer of an artificial stone mix uniformly over a planar work surface, compacting the dispersed artificial stone mix by applying pressure, placing the first fiber layer, and coating the first fiber layer with a thin coating of resin mix. The first fiber layer is, for example, a glass fiber mat. The artificial stone mix is, for example, compacted by vibrocompaction. The central composite core comprises one or more of multiple porous ceramic blocks and porous ceramic pieces, and artificial stone mix. Manufacturing the central composite core comprises: placing a reinforcing grid on the first artificial stone skin, placing one or more of the porous ceramic blocks and the porous ceramic pieces on the first artificial stone skin, placing artificial stone mix around the porous ceramic blocks or pieces whereby the artificial stone mix fills gaps between the porous ceramic blocks and the porous ceramic pieces to create a solid central composite core, and placing the second artificial stone skin backed with the second fiber layer on the central composite core. The second artificial stone skin backed with the second fiber layer is manufactured similar to the first artificial stone skin backed with the first fiber layer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 exemplarily illustrates a sectional view of a body structure for a door.

FIG. 2 exemplarily illustrates a sectional view of a body structure for a table.

FIG. 3 exemplarily illustrates a sectional view of a body structure for a window.

FIG. 4 illustrates a method of manufacturing a body structure with a structural foam filled central composite core.

FIGS. 5A-5B illustrate a method of manufacturing a body structure with an artificial stone mix filled central composite core.

### DETAILED DESCRIPTION OF THE INVENTION

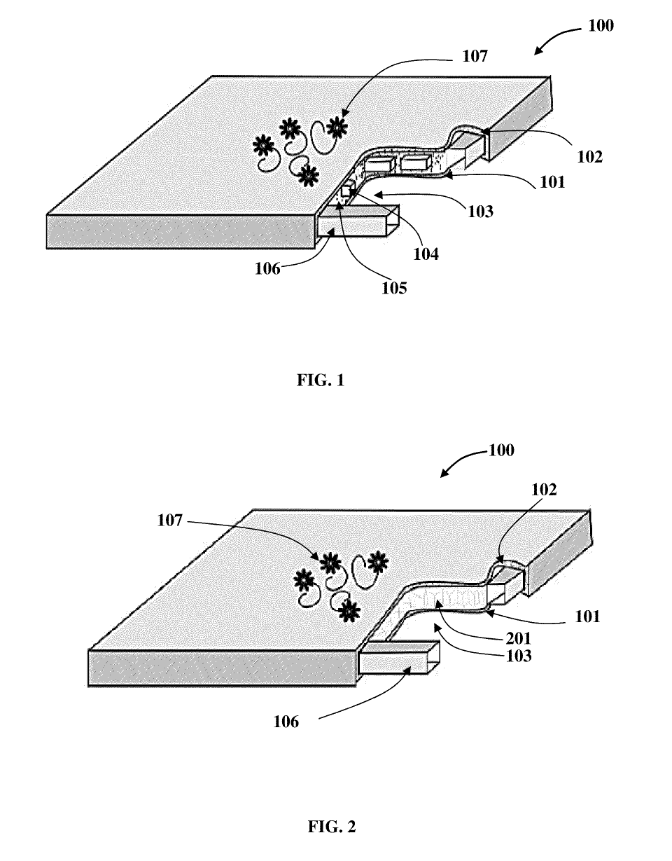

The body structure 100 for a door and/or other furniture comprises a first artificial stone skin 101 backed with a first fiber layer, a second artificial stone skin 102 backed with a second fiber layer, and a central composite core 103 positioned between the first artificial stone skin 101 and the second artificial stone skin 102. FIG. 1 exemplarily illustrates a sectional view of a body structure 100 for a door. The central composite core 103 is one or a combination of a structural foam 105 and porous ceramic blocks and porous ceramic pieces 104. The porous ceramic blocks and porous ceramic pieces 104 are herein referred to as “porous ceramic”. The structural foam 105 is, for example, a polyurethane foam. The fiber is one or a combination of glass fiber, carbon fiber, metal fiber, ceramic fiber, and aramid fiber, preferably glass fiber. In order to manufacture porous ceramic 104, a ceramic slip is prepared, a preform is created from the ceramic slip, and placed on a silicon carbide support and subjected to a predetermined firing cycle. Further, in order to prepare ceramic slip, ceramic powder suspension is mixed with at least one stabilizing agent, at least one foaming agent and mixed rigorously at room temperature. The mixture is dried gradually to eliminate surface cracks during the drying cycle. The ceramic slip is heated to the sintering temperature and gradually cooled to room temperature. Table 1 shows a ceramic slurry composition that, after firing, results in a porous ceramic 104 with a density of 0.3 g/cm³.

TABLE 1

| Ingredient | parts by weight |
|---|---|
| Ball Clay | 10 |
| China Clay | 20 |
| Feldspar | 45 |
| Quartz | 10 |
| Talc | 5 |
| Wollastonite | 5 |
| Calcium sulphate hemihydrate | 5 |
| Hydrogen peroxide solution | 4 |

In order to prepare a ceramic slip, the composition in Table 1 is mixed with water. The ceramic slip is shaped into a preform. The ceramic preform is then placed on a silicon carbide support and heated to 1130 deg C. over a period of 4 hours. The ceramic slip transforms into a porous ceramic 104 body during the said firing cycle. The hot porous ceramic 104 body is allowed to gradually cool to room temperature. It is possible for those skilled in the art to effect numerous changes and modifications in the composition and firing cycle without deviating from the scope and spirit of the invention.

Decorative material 107 may be embedded within one or more of the artificial stone skins 101 and 102. The decorative material 107 comprises one or more of ornamental glass, semiprecious stone, colored quartz, glass or stone jewelry. In an embodiment, the body structure 100 further comprises a reinforcing grid 106. The reinforcing grid 106 is, for example, a metal grid. The artificial stone skins 101 and 102 further comprise particulates and resin. The particulates are, for example, one or more types of quartz, granite, glass, ceramic or a combination thereof. The size of particulates varies from less than 0.5 mm to approximately 3 mm. The size distribution, for example, follows Fuller's formula so as to achieve maximum compaction. The resin is an unsaturated polyester resin solution. An example of an artificial stone mix composition is approximately 85% to 95% of quartz stones 5%-15% of an unsaturated polyester resin solution. Another example of an unsaturated polyester resin solution is a combination of ortho neopentyl glycol, methyl methacrylate, and styrene. Another example of an unsaturated polyester resin solution is a combination of iso neopentyl glycol, methyl methacrylate, and styrene. Room temperature catalysts such as methyl ethyl ketone peroxide (MEKP) in combination with an accelerator are used as a curing system. In another embodiment, high temperature setting catalysts such as dimethyl aniline (DMA), cumyl hydroperoxide (CHP) is used. In the curing system, other ingredients used are, for example, a dispersing agent, a stabilizing agent, a coupling agent, pigments, etc. Tables 2-4 exemplarily illustrate the compositions of the artificial stone mix.

TABLE 2

| Ingredient | Parts by weight |
|---|---|
| Unsaturated Polyester resin solution | 14 |
| (Unsaturated polyester resin, styrene | |
| monomer, methyl methacrylate monomer) | |
| Quartz (particles size <3.0 mm) | 84 |
| Benzoyl peroxide | 1 |
| Dimethyl Aniline (DMA) | 1 |

Curing was carried out at 70 deg C. for 15 minutes.

TABLE 3

| Ingredient | Parts by weight |
|---|---|
| Unsaturated Polyester resin solution | 12 |
| (Unsaturated polyester resin, styrene | |
| monomer) | |
| Quartz (particles size <3.0 mm) | 86 |
| Benzoyl peroxide | 1.0 |
| Dimethyl Aniline (DMA) | 1.0 |

Curing was carried out at 70 deg C. for 15 minutes.

TABLE 4

| Ingredient | Parts by weight |
|---|---|
| Unsaturated Polyester resin solution | 10 |
| (Unsaturated polyester resin, styrene | |
| monomer, methyl methacrylate monomer) | |
| Quartz (particles size <3.0 mm) | 89 |
| Methyl Ethyl Ketone Peroxide (MEKP) | 0.5 |
| Cobalt Naphthenate | 0.5 |

Curing was carried out at room temperature.

In order to manufacture the structural foam 105, calculated quantities of polyol, polyisocyanate and water are mixed thoroughly using a stirrer and poured immediately over the intended areas and spread evenly over the surface.

Tables 5-6 display compositions of polyurethane foaming liquid.

TABLE 5

| Ingredient | Parts by weight |
|---|---|
| Polyol | 45 |
| Polyisocyanate | 54 |
| Water | 1 |

TABLE 6

| Ingredient | Parts by weight |
|---|---|
| Polyol | 48 |
| Polyisocyanate | 52 |

In order to manufacture one of the artificial stone skins 101 and 102, the stone mix is deposited over the planar surface and pressure applied to compact the artificial stone mix. A fiber mat backing is placed on the compacted artificial stone mix and coated with a layer of resin mix to create one of the artificial stone skins 101 and 102. The resin mix has, for example the same composition as the resin system of the artificial stone mix used in the artificial stone skins 101 and 102. Vacuum is additionally applied for better compaction and removal of air cavities. The pressure is generated, for example, by the use of a heavy roller. Another method of generating the pressure is through a vibrating compactor, wherein the compactor is a hydraulic or a pneumatic compactor, capable of generating pressures of upto 10 kg/cm².

The steps of manufacturing a central composite core 103 comprises placing blocks or pieces of porous ceramic 104 between the artificial stone skins 101 and 102, and introducing a mixture of polyol and polyisocyanate in between the artificial stone skins 101 and 102 and in the cavities between blocks or pieces of porous ceramic 104, whereby the structural foam 105 fills the gaps between the blocks or pieces of porous ceramic 104, sets and creates a solid central composite core 103. The structural foam 105 penetrates not only the space between blocks or pieces of porous ceramic 104, but also penetrates the exposed pores on the surface of the porous ceramic 104. The mix ratio of polyol and polyisocyanate varies from 1:1 to 1:1.5. In order to create the body structure 100 comprising outer artificial stone skins 101 and 102 and inner central composite core 103, the following manufacturing steps are followed. A reinforcing grid 106 is placed on one of the artificial stone skins 101 and 102, blocks of porous ceramic 104 is placed within the reinforcing grid 106, the polyol and polyisocyanate mixture poured evenly on and around the blocks or pieces of porous ceramic 104, then another of the artificial stone skins 101 and 102 is placed on the reinforcing grid 106 and, the entire assembly is clamped between two stiffened steel platens until the foaming is completed inside the reinforcing grid 106. The clamping is effected to withstand outward pressures of upto 10 kg/cm² generated during the foaming process. The artificial stone skins 101 and 102 are polished and sized by the usual techniques applied in granite polishing.

In another embodiment, the body structure 100 for a door and/or other furniture comprises a central composite core 103 further comprising structural foam 105 and porous ceramic 104, top and bottom artificial stone skins 101 and 102 comprising fiber reinforced artificial stone, a reinforcing grid 106 placed between the top and bottom artificial stone skins 101 and 102, and a fiber reinforced resin layer devoid of artificial stone mix that overlays the section of reinforcing grid 106 that boundaries the door and/or furniture, whereby the accessories such as locks, bolts, handles, etc. are attached to the boundary section of the reinforcing grid 106.

The body structure 100 of a table comprises a central composite core 103 further comprising a structural foam 105 and a porous ceramic 104, a top artificial stone skin 102 and a bottom artificial stone skin 101 comprising fiber reinforced artificial stone, and a reinforcing grid 106 placed between the artificial stone skins 101 and 102. The reinforcing grid 106 is, for example a metal frame or a metal grid and provides greater rigidity to the body structure 100.

In order to manufacture a table, the reinforcing grid 106 is placed on the first artificial stone skin 101, blocks or pieces of porous ceramic 104 are placed inside the reinforcing grid 106, liquid structural foam 105 poured around the blocks or pieces of porous ceramic 104, the second artificial stone skin 102 is placed on the reinforcing grid 106, and the entire body structure 100 is clamped between two stiffened metal platens until the foaming process is completed. The clamping is effected to withstand upto 10 kg/cm² of outward pressure exerted by the expanding foam 105. In order to manufacture artificial stone skins 101 or 102, the artificial stone mix is compacted over the release sheet, a glass fiber mat placed over the compacted artificial stone mix, and the fiber mat is coated with a resin mix. The resin mix, for example, has the same composition as the resin system of the artificial stone mix used in the artificial stone skins 101 and 102.

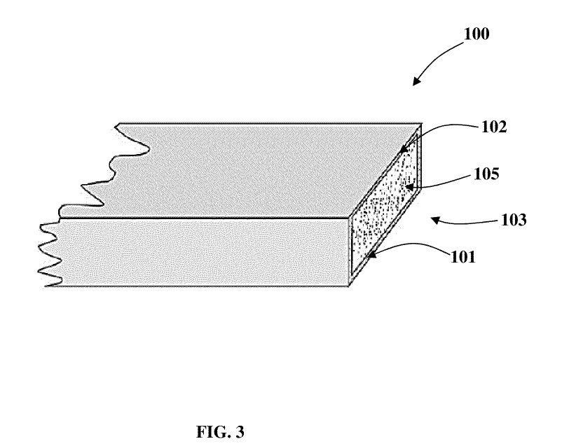

FIG. 2 exemplarily illustrates a sectional view of a body structure 100 for a table. In another embodiment, the body structure 100 of a table comprises a first artificial stone skin 101 and a second artificial stone skin 102 comprising fiber reinforced artificial stone and a honeycomb structure 201 placed between the artificial stone skins 101 and 102 and inside the reinforcing grid 106. The honeycomb structure 201 is, for example, a paper honeycomb, reinforced plastic honeycomb, plastic honeycomb or an aluminum honeycomb.

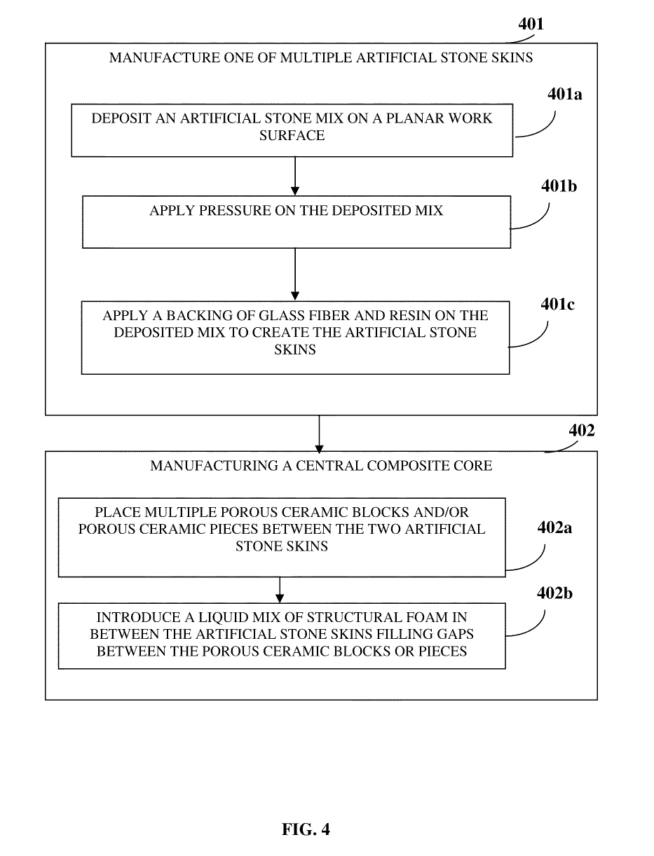

A body structure 100 of a window rim as illustrated in FIG. 3 comprises a central composite core 103 and a top artificial stone skin 102 and a bottom artificial stone skin 101 comprising fiber reinforced artificial stone. The central composite core 103 comprises structural foam 105, preferably a polyurethane foam. In another embodiment, the body structure 100 of a window rim comprises top and bottom artificial stone skins 101 and 102 comprising fiber reinforced artificial stone and a honeycomb structure 201 placed between the artificial stone skins 101 and 102. In order to manufacture a window rim, the central composite core 103 is placed on the first artificial stone skin 101 that is still in the green stage, the assembly of first artificial stone skin 101 and the central composite core 103 is placed on the second artificial stone skin 102 such that the central composite core 103 is in contact with the second artificial stone skin 102 that is still in the green stage. The entire assembly is clamped between two stiffened metal platens until both the artificial stone skins 101 and 102 have cured completely. The clamping is effected to exert pressures of upto 10 kg/cm². In order to manufacture the artificial stone skins 101 and 102 an artificial stone mix is placed over the release sheet, compacted, a glass fiber mat placed over the compacted artificial stone mix and coated with the resin mix. The resin mix has, for example, the same composition as the resin system of the artificial stone mix used in the artificial stone skins 101 and 102.

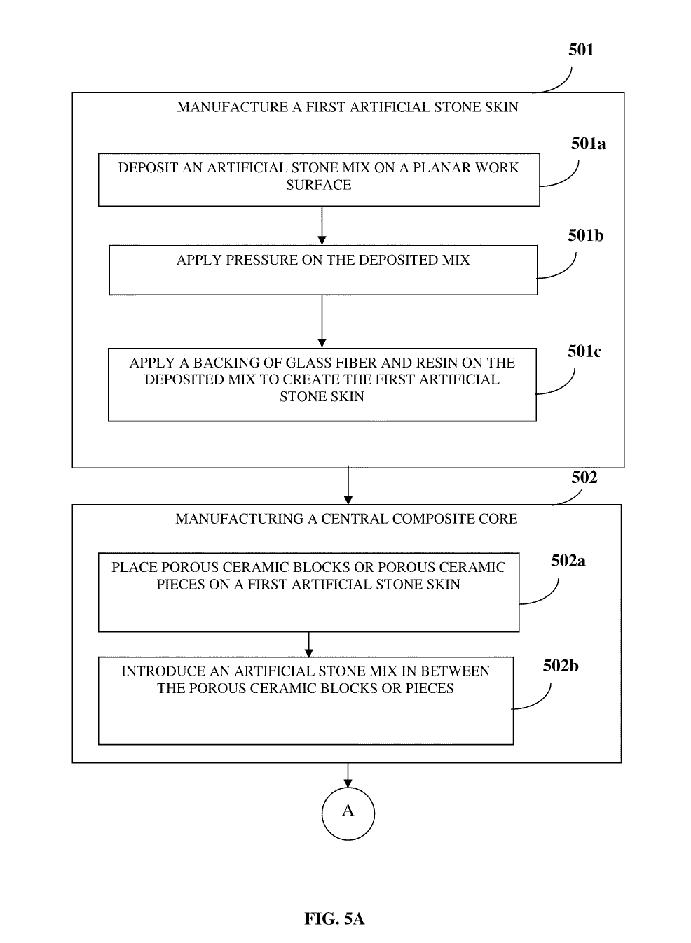

FIG. 4 illustrates a method of manufacturing a body structure 100 with a structural foam 105 filled central composite core 103. The body structure 100 is manufactured by manufacturing multiple artificial stone skins 101 and 102 and manufacturing a central composite core 103. Manufacturing 401 multiple artificial stone skins 101 and 102 comprises: depositing 401a the artificial stone mix on a planar work surface, applying 401b pressure on the deposited mix to compact the deposited artificial stone mix, applying 401c a backing of glass fiber and resin on the compacted artificial stone mix to create one of multiple artificial stone skins 101 and 102. The fiber layer imparts toughness and rigidity to the compacted artificial stone mix. Manufacturing 402 the central composite core 103 comprises: placing 402a multiple porous ceramic blocks or pieces 104 between the two artificial stone skins 101 and 102 and introducing 402b a liquid mix of structural foam 105 in between the artificial stone skins 101 and 102 filling gaps between the porous ceramic 104 blocks and pieces. The structural foam 105 holds the porous ceramic 104 blocks or pieces together and provides rigidity to the body structure 100.

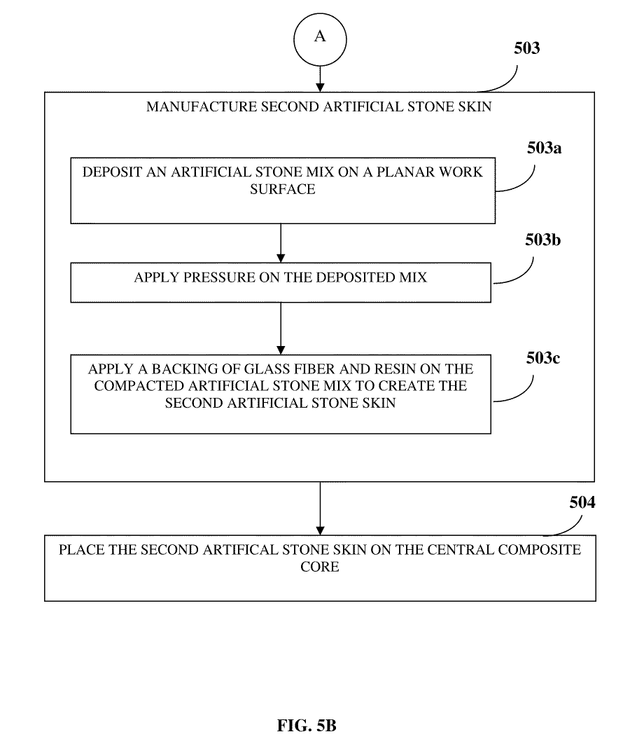

FIGS. 5A-5B illustrate a method of manufacturing a body structure 100 with an artificial stone mix filled central composite core 103. The body structure 100 is manufactured by manufacturing a first artificial stone skin 101 and a second artificial stone skin 102, manufacturing a central composite core 103, and placing the second artificial stone skin 102 on top of the central composite core 103. Manufacturing 501 the first artificial stone skin 101 comprises: depositing 501a an artificial stone mix on a planar work surface, applying 501b pressure on the deposited mix to compact the deposited artificial stone mix, and applying 501c a backing of glass fiber and resin on the compacted artificial stone mix to create the first artificial stone skin 101. The fiber layer imparts toughness and rigidity to the compacted artificial stone mix. Manufacturing 502 the central composite core 103 comprises: placing 502a multiple porous ceramic 104 blocks or pieces on the first artificial stone skin 101 and introducing 502b an artificial stone mix between the porous ceramic 104 blocks or pieces thereby filling the gaps between porous ceramic 104 blocks or pieces. The artificial stone mix, on curing provides rigidity to the body structure 100 and holds the porous ceramic 104 blocks or pieces in place, while the porous ceramic 104 reduces the overall weight and improves fire resistance of the body structure 100.

Manufacturing 503 the second artificial stone skin 102 comprises: depositing 503a an artificial stone mix on a planar surface, applying 503b pressure on the deposited mix to compact the deposited artificial stone mix, and applying 503c a backing of second glass fiber and resin on the compacted artificial stone mix thereby creating the second artificial stone skin 102.

The method of manufacturing further comprises the step of placing 504 the second artificial stone skin 102 on the central composite core 103 to create the body structure 100.

The foregoing examples have been provided merely for the purpose of explanation and are in no way to be construed as limiting of the invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A body structure for a door and/or furniture, comprising:
a first artificial stone skin backed with a first fiber layer;
a second artificial stone skin backed with a second fiber layer; and
a lightweight central composite core positioned between said first artificial stone skin and said second artificial stone skin.

2. The body structure of claim 1, wherein said central composite core comprises:
one or more of a plurality of porous ceramic blocks and porous ceramic pieces; and
structural foam filling gaps between said porous ceramic blocks and said porous ceramic pieces.

3. The body structure of claim 1, wherein said central composite core comprises:
one or more of a plurality of porous ceramic blocks and porous ceramic pieces; and
an artificial stone mix filling gaps between said porous ceramic blocks and said porous ceramic pieces.

4. The body structure of claim 1, wherein said central composite core further comprises a reinforcing grid between said first artificial stone skin and said second artificial stone skin.

5. A method of manufacturing a body structure for a door and/or furniture, comprising:
manufacturing one of a plurality of artificial stone skins, comprising:
depositing an artificial stone mix on a planar work surface;
applying pressure on said deposited mix; and
applying a backing of glass fiber and resin on said deposited mix to create said one of said artificial stone skins; and
manufacturing a central composite core, comprising:
placing one or more of porous ceramic blocks and porous ceramic pieces between two of said artificial stone skins; and
introducing a liquid mix of structural foam in between said two of said artificial stone skins, wherein said structural foam fills gaps between said porous ceramic blocks and said porous ceramic pieces, sets, and creates a solid central composite core.

6. A method of manufacturing a body structure for a door and/or furniture, comprising:
manufacturing one of a plurality of artificial stone skins, comprising:
depositing an artificial stone mix on a planar work surface;
applying pressure on said deposited mix; and
applying a backing of glass fiber and resin on said deposited mix to create one of said artificial stone skins;
manufacturing a central composite core, comprising:
placing one or more porous ceramic blocks and porous ceramic pieces on one of said artificial stone skins; and
introducing said artificial stone mix in between said porous ceramic blocks and said porous ceramic pieces, wherein said introduced artificial stone mix fills gaps between one or more of said porous ceramic blocks and said porous ceramic pieces, sets, and creates said central composite core with a continuous interface layer between said porous ceramic blocks, said porous ceramic pieces, and said artificial stone mix; and
placing another one of said artificial stone skins on top of said central composite core.

7. The method of claim 6, further comprising introducing a reinforcing grid between said artificial stone skins.

8. The method of claim 6, wherein said artificial stone skins are manufactured by applying vibrocompaction.
